(19) United States
(12) Patent Application Publication
(10) Pub. No.: US 2022/0177282 A1
(43) Pub. Date: Jun. 9, 2022

(54) METHOD AND DEVICE FOR TENSIONING A STRAP

(71) Applicant: PUSH4M, Groix (FR)

(72) Inventor: Nicolas De Lussy, Groix (FR)

(73) Assignee: PUSH4M, Groix (FR)

(21) Appl. No.: 17/436,341

(22) PCT Filed: Mar. 6, 2020
(86) PCT No.: PCT/EP2020/056074

§ 371 Date: Sep. 3, 2021

(30) Foreign Application Priority Data
Mar. 6, 2019 (FR) 1902282

(51) Int. Cl. B66C 23/82; B66F 13/00

(52) U.S. Cl. CPC B66C 23/82; B25J 9/1045; B66F 13/00

(57) ABSTRACT

The invention relates to a method and to a device for implementing the method for tensioning an inextensible or substantially inextensible longitudinal strap (12) comprising a distal end portion (15) and a proximal end portion (11), each end portion being respectively fixed to a corresponding attachment point (13, 16). The method is characterized in that a cycle (2) of successive transverse pressure applications is exerted on the strap (12), comprising a first transverse pressure application (23) on a first portion (20) of die strap then a second (24) and a third (25) transverse pressure application on a second (21) and a third (22) portion of the strap, respectively.

The present invention relates to a method for tensioning an inextensible or substantially inextensible strap notably for lifting a load from a distance or else for moving in space a significant mass situated at an end remote from the actuating mechanism.

It also relates to a tensioning and/or movement device employing such a method.

It finds a particularly important, although not exclusive, application in the field of building and public works, for site equipment or for devices for handling heavy loads requiring a significant force for lifting-off and/or detaching the load at the outset.

However, it is also applicable to the field of robotics and exoskeletons, to the field of prosthetics and orthotics for man and more generally to all fields of mechanics requiring a preload on an inextensible or substantially inextensible longilinear member and/or the application of movement to a lever arm or the application of a tensile force that requires a significant force and/or a significant speed at the outset.

What is meant by a substantially inextensible member is a member designed to experience elongation of less than 5% of its length for a determined maximum tensile force below its breaking point of, for example, 500 MPa, for example less than 3%, advantageously less than 1%, more advantageously still, less than 0.5% or even 0.05%.

Devices that allow heavy loads to be handled from a distance using a lever arm are already known.

However, these have disadvantages, particularly in terms of cost and bulk.

These are, for example, power rams which are not easy to handle and that are found in autonomous vehicles of the lift truck, excavator or mechanical shovel type, or else rotary motors used for example in vehicles mounted on a base, of the factory robot type, the operating torque of which is dependent on their weight, and which will therefore have a tendency to be oversized.

In addition, the force that will act on the lever arm rotation axle is necessarily coupled to the movement of the load, without the possibility of dissociation, whether the actuator engages directly with the lever arm or whether it does so via a deformable quadrilateral.

Thus, the current setups, whether these involve linear actuators or rotary motors, necessarily have to deliver a maximum power for equalizing the resistive torque at each instant of the movement. This leads to a significant expenditure in terms of energy, imposes a high weight on the drive elements and leads to greater wearing of the mechanical parts.

It is an object of the present invention to overcome these disadvantages notably by dissociating the force exerted on the lever arm from the movement of the actuator.

In order to do this, the invention takes an entirely different approach from that of the prior art. It is derived from careful observation of the working of an arm muscle, and more particularly of the biceps which, in order to lift a load in the hand situated at the end of the forearm (lever arm), does not decrease in length but stiffens the biceps by increasing the transverse volume of the muscle fibers of which it is made.

With the invention, the equivalent of a catch of transverse volume causes the tensioning of a somewhat inextensible tie or ligament and, in this instance, the movement in space of a significant mass at the end of the arm, in a way that is at the very least equivalent to a longitudinal shortening but which, above all and surprisingly, produces a very high lift-off force for a minimum movement, thus operating on a principle equivalent to that of a reverse block and tackle.

To this end, the invention notably proposes a method for tensioning an inextensible or substantially inextensible longitudinal strap comprising a distal end portion and a proximal end portion, each end portion being respectively fixed to a corresponding anchor point, characterized in that a cycle of successive applications of transverse pressure to the strap is applied, this cycle comprising a first application of transverse pressure to a first portion of the strap, followed by a second and a third application of transverse pressure to a second and to a third portion of said strap respectively without relaxing the tension between the two successive applications of pressure.

No relaxing of the tension of the strap occurs between the successive applications of tension or, where applicable, between the various tension application cycles.

What is meant by the application of transverse pressure or thrust is the application of a force initially perpendicular and then substantially perpendicular (+a few degrees increasing progressively with respect to 90°) to the strap with respect to its initial longitudinal direction without movement “in its plane”.

Advantageously, the portions of strap to which the pressures are applied are short in length by comparison with the length of the strap between the end portions, for example of the order of 0.2% to 1%, for example 0.5%, of the length, namely for example less than 5 cm, for example than 1 to 2 cm, for a strap 1 m long.

The strap may of course be a cable, a belt, a chain, a tie or more generally any longilinear member for example formed of inextensible or substantially inextensible fibers, for example a material known by the brand name DYNEEMA which has a very high tensile strength, for example in excess of 500 MPa, and which nevertheless maintains sufficient flexibility to be able to absorb a great many cycles of deformation in bending over a determined maximum height per cycle (for example 50.000 cycles over a height of a few centimeters, for example 5 cm).

Advantageously, with the proximal end portion of the strap fixed to a base by a first of the anchor points and the distal end portion of the strap fixed to a proximal part of a lever arm rotationally mobile about an axle by the second of the anchor points, said lever arm extending between said proximal part and a distal part designed to support a load, the successive applications of pressure are designed to actuate the lifting of said lever arm between a first, rest, position and a second, working, position.

The rest position or low position is, for example, a position in which the arm is horizontal, and the working position or raised position is a position in which the arm is vertical, or at an angle of between 30° and 80°, for example 50°, to the horizontal.

The invention thus proposes a method for lifting a load fixed at a distal end of a lever arm rotationally mobile about a transverse axle situated on the side of a proximal part of the lever arm, by applying at least one pressure application cycle, this cycle being performed in the form of transverse thrusts on the inextensible or substantially inextensible strap fixed on one side to said proximal part of said arm and on the other side to a fixed point, in which method the applications of transverse pressure are performed in successive vertical thrusts in the plane of movement to said strap at least at three locations distributed along this strap.

In advantageous embodiments, recourse is further had to one and/or another of the following arrangements:
the second and third applications of pressure are distributed symmetrically or substantially symmetrically on either side of the first application of pressure. What is meant by substantially symmetrically is as symmetrically as possible, that is to say without exceeding a few centimeters away from the strictly symmetrical position.
the second and third applications of pressure are applied successively. By applying successive thrusts to the second and third portions the power required to increase the tension is thus limited. The time that elapses between successive thrusts is for example less than 1/10th of a second or 1 hundredth of a second, so that the cycle applied by the motor means is not cumulative;
in order to perform the applications of pressure, the first, second and third portions of strap are moved vertically over, respectively, a first, second and third determined height, then the first portion is moved once again over a new determined height;
the second and third determined heights are equal through symmetry. However, in the event of asymmetric thrusts, the heights are dependent on each thruster position;
the determined heights are designed so that the angles adopted by the strap with respect to the straight line formed between the portions of strap and/or adjacent to the portions to which pressure is applied are between 5° and 15°, for example 10°. The parts of strap and/or anchor points then become the fulcrums for the ends of the part of strap moved:
the pressure application cycle is repeated at least N times, where N≥2, for example N≥3 or N≥5, for example 10 times;
at least one cycle comprises at least a fourth and a fifth application of transverse pressure to a fourth and a fifth portion of strap respectively and/or an nth and an n+1th application of pressure to an nth and an n+1th portion of strap where n≥6, the nth and n+1th portions being situated respectively on either side of the n−2th and n−1th portions of strap. They may also be situated towards the inside of the previous applications of pressure, namely in the direction or on the side of the first thrust. In this instance, multiple combinations will be able to be programmed, for example if there are n thrust points the cycles will be 1-2-3-4-5- . . . n then 1-2-3-4-5- . . . n again, etc. However, beyond n=3, the cycles may follow a different sequence e.g.: 1-2-3-5-4-1-2-1-4-3, etc. as required.
the applications of pressure to the strap are performed via rotary cams configured to permit the successive pressure-application cycle or cycles for determined values of thrust and/or for vertical movements of the strap over determined heights.

The use of cams allows excellent continuity and a high level of flexibility in the increases in pressure, as well as perfect mechanical repeatability of the movements.

The invention also proposes a device implementing the method or methods described above.

It also relates to a device for tensioning an inextensible or substantially inextensible strap extending longitudinally between a distal end portion and a proximal end portion, each of which are respectively fixed to corresponding anchor points, characterized in that it comprises thruster means for applying transverse pressure to the strap, comprising first thruster means for applying transverse pressure to a first portion of strap, second and third thruster means for applying transverse pressure to a second and to a third portion of strap respectively, and control means controlling said pressure-application thruster means and designed to perform at least one cycle of successive applications of pressure to the strap on said first, second and third portions of said strap in a determined manner.

Advantageously, the thruster means comprise rotationally mobile cams programmed and/or configured to allow the determined successive pressure application cycles.

However, it is also possible, for example, to use vertically thrusting hydraulic or electric actuators with identical or different strokes, of lengths determined in a preprogrammed manner.

In one advantageous embodiment, the device additionally comprises a lever arm extending longitudinally between a proximal part and a distal part for supporting a load, the proximal part being rotationally mobile about an axle fixed to a base, the distal end portion of the strap being for its part fixed to said proximal part of the arm by one of the anchor points, directly or via a pulley and/or for example an axle of the rotary cylinder type, and the proximal end portion of the strap being fixed to a fixed point forming the second of the anchor points for example secured to the base.

Advantageously, the strap, the thruster means and the arm rotation axle are secured to the one same base.

Advantageously also, the base is mobile, for example mounted on a mobile chassis, thereby allowing the device to be moved around, for example by a self-propelled vehicle.

In advantageous embodiments, the thruster means comprise a single rotary motor for actuating cams designed to perform one or more cycles of determined applications of transverse pressure to the strap.

Advantageously, the three thruster means (or systems) comprise a central means and two lateral means positioned symmetrically with respect to the central means.

Also advantageously, the number of thruster means is not limited to three, but comprises n+2 thruster means where n is an uneven number greater than or equal to 3, distributed longitudinally along the strap, for example, symmetrically with respect to the central thruster means situated equidistant between the fixed strap fixing point and a rotary cylinder or pulley for returning the strap, said pulley or said cylinder being situated in the same longitudinal plane as said fixed point.

Advantageously, each thruster means comprises:
a cam in the form of a substantially circular disk comprising, on one of its faces, a guide groove or rail in the form of a concentric spiral of determined length and trajectory;
a guide roller designed to collaborate through friction or rolling with the groove or rail, said roller being secured to a thruster system (or push rod) ending at the top in a ring or a rotary cylinder designed to collaborate with the strap in such a way as to transmit the thrust of the thruster system to it according to the determined pressure cycle or cycles.

It will be appreciated that the dynamics of such a device are connected to the geometry of the cams. Indeed it is these that dictate the determined movement of the thruster system (the movement of the strap in terms of height and in terms of speed) and therefore the upward movement of the arm, as well as the torques (lift-off and operating torques) needed for setting the arm in motion.

Note that the slope of the groove of the cam allows the torque and the speed to be varied, for the one same circular movement. Thus, a shallow slope results in a high torque and a low speed, and conversely a steep slope results in a low torque and a higher speed. Varying the slopes therefore makes it possible to alter the speed/torque ratio at various moments in the movement. What is meant by the slope of the groove is the angle that the tangent to the curve makes with the horizontal at the location of the roller.

In an example of a set of grooved cams implemented with the invention (which groove a person skilled in the art will therefore dimension according to the desired operating parameters, dependent notably and in a known way on the length of the lever arm between its rotation axle and its distal end for attachment to the weight that is to be lifted, the value of said weight and the height to which the arm is to lift said load) there is found, with three thruster means, a reduction in speed by a factor of six, for an increase in drive torque varying between 3.7 and 6 with respect to the motor speed and torque required to lift the load through direct action on the rotation of the lever arm axle. This sharply highlights the non-linearity of the system.

Another example of a set of cams produced made it possible to achieve a torque increase by a factor in excess of twelve, for a speed reduction by a factor of ten.

The invention will be better understood from reading the following description of embodiments given hereinafter by way of nonlimiting examples.

The description refers to the accompanying drawings, in which:

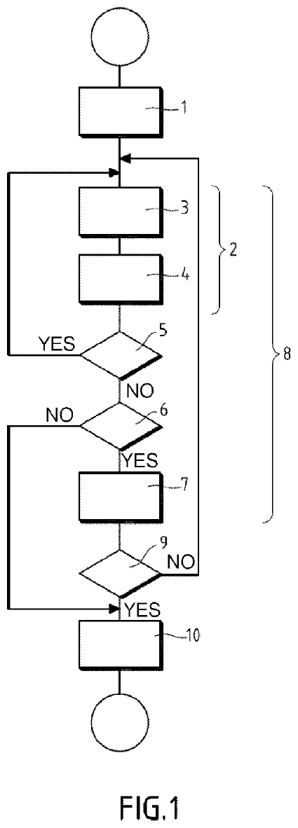

FIG. 1 is a flow diagram of a method for lifting a load according to one embodiment of the invention, with the application of pressure to five portions of strap.

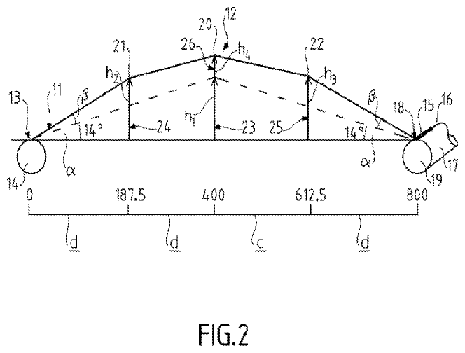

FIG. 2 shows the diagram of forces applied to a strap according to the embodiment of the invention more particularly described here, applied to three portions of strap.

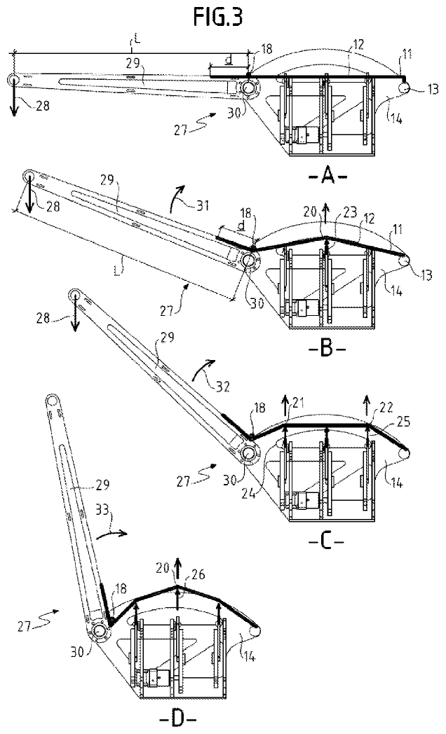

FIG. 3 shows, in side view, a device according to one embodiment of the invention, prior to the application of the first thrust (according to the diagram of FIG. 2), the lever arm being in its lowered or rest position (FIG. 3A), after the first thrust (FIG. 3B), after the 2^{nd} and 3^{rd} thrusts (FIG. 3C), and after the 4^{th} thrust, the lever arm being in its raised position (FIG. 3D).

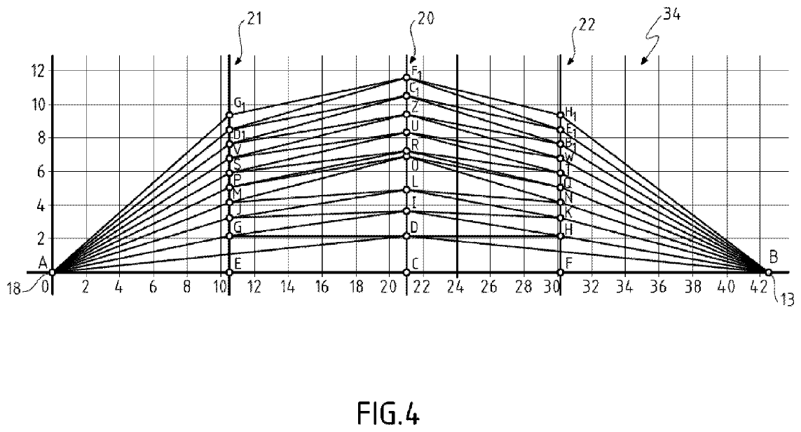

FIG. 4 is a diagram of forces showing a succession of cycles of thrust on the strap of the type shown with reference to FIG. 2.

FIG. 5 shows the curve of the variation in thrust heights achieved by the central and lateral thrusting means according to the embodiment of the device of the invention more particularly described here.

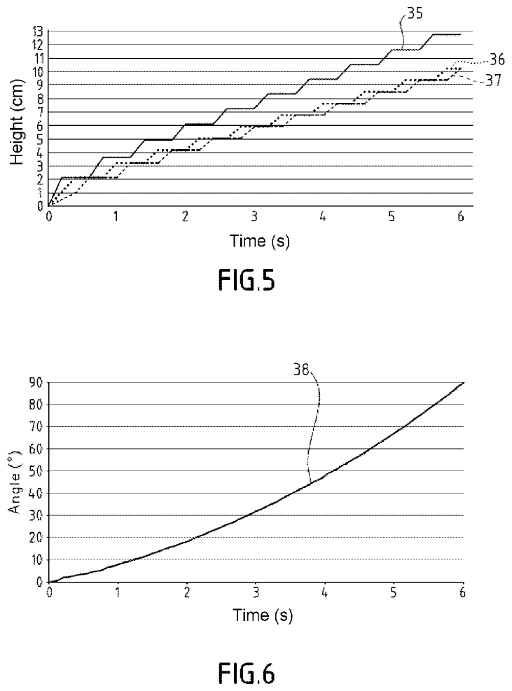

FIG. 6 shows the curve of the variation in the angle adopted by the lifting arm as a function of time, corresponding to the variations in height of FIG. 5.

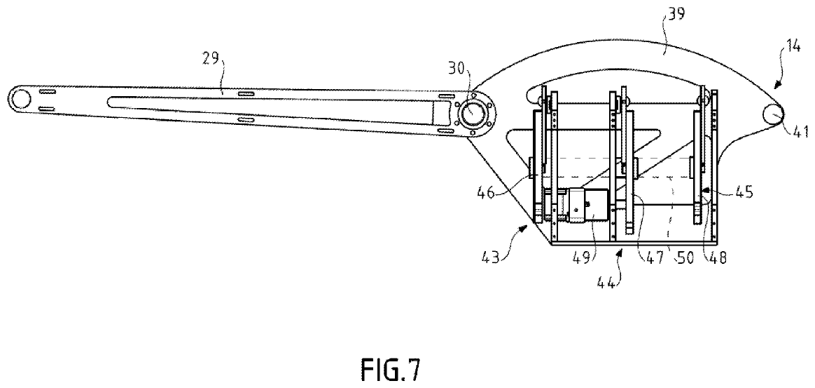

FIG. 7 is a side view of the lifting device according to the embodiment of the invention more particularly described here.

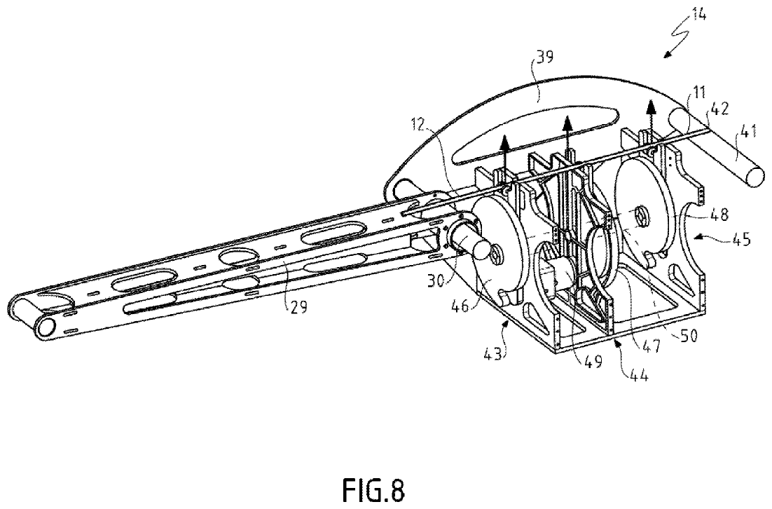

FIG. 8 is a view in axionometric perspective of FIG. 7.

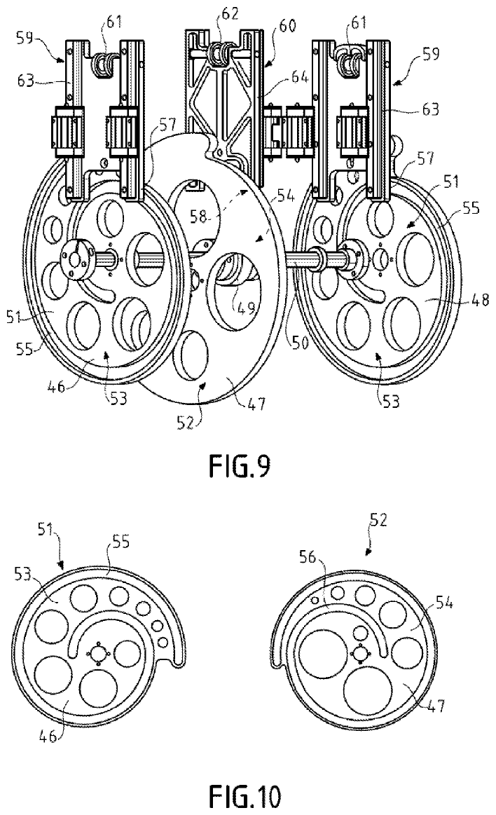

FIG. 9 is a perspective view of the three cams of the device of FIG. 7.

FIG. 10 shows, in side view, the central and lateral cams of FIG. 9.

FIG. 1 shows a flow diagram 1 of a method of lifting a load according to an embodiment of the invention.

To do this, the load (for example a 500 kg portion of pipeline tube) is fixed to a lifting device and, more particularly, to a distal part of a lever arm (step 1), the proximal part of the lever arm having itself been fixed at one of its ends to the distal portion of an inextensible strap extending longitudinally and horizontally, itself fixed at its other end, referred to as the proximal end, to a fixed point, for example belonging to a truck or to a base secured to the ground on which it rests.

In order to raise the load, which will for example allow space to be cleared beneath it, so that it can be recovered and/or set down on a support, a first cycle 2 of applications of transverse pressure, in this instance vertical (namely transverse with respect to the horizontal initial position of the strap) is applied to said strap.

More specifically, the cycle 2 comprises a first application of pressure 3 to a first portion of the strap, for example arranged substantially centrally with respect to the points of attachment of the strap to the base and to the proximal part of the lever arm respectively.

Next, a 2^{nd} and a 3^{rd} application of transverse pressure are applied simultaneously and/or successively to the strap (step 4) on a 2^{nd} and on a 3^{rd} portion of the strap respectively, this, because of the inextensible or substantially inextensible nature of the strap, causing the lever arm to lift, for example by a few centimeters.

Depending on the configuration of the load that is to be lifted, and notably its location with respect to the positioning of the lifting device comprising the strap, the decision may or may not (step 5) be taken to repeat the applications of pressure of steps 3 and 4.

It is also possible to decide, if the cycle 2 is not to be repeated definitively or simply immediately, whether or not (step 6) to apply pressure (step 7) to a 4^{th} and a 5^{th} portion of strap, these for example being positioned symmetrically towards the outside of the second and third portions, this being something that allows the lifting movement of the arm to continue more progressively, via a cycle 8 comprising steps 3, 4 and 7.

The cycle 8 may or may not (test 9) be repeated in order to continue to lift the lifting arm before the cycle is ended with a final step 10, for example identical to the step 3, for a different height.

Thus, through successive applications of pressure the first, 2^{nd}, 3^{rd} and, where applicable, 4^{th} and 5^{th} portions of strap are moved vertically over first, 2^{nd}, 3^{rd}, 4^{th}, 5^{th} etc. determined heights or distances respectively, these movements potentially being repeated several times, before ending for example with a movement of the first portion over a new height causing the arm to lift between a first, rest, position and a final, so-called working, position.

FIG. 2 depicts an outline diagram illustrating one simple embodiment of the invention performing steps 3 and 4 and then 10 without repeating the cycle 2 and without applying pressure to other portions of strap.

The proximal end portion 11 of the strap 12 is fixed at 13 to a base 14, its distal end portion 15 being fixed at 16 to the proximal part 17 of a lever arm, an axle 18 for holding the portion substantially adjacent to the distal end portion 15 of the strap making it possible to maintain the fixed points for the strap, on the one hand on the base of the device and, on the other hand, on or close to the fixed axle 19 of rotation of the lever arm.

The centers of the portions of strap 20, 21, 22 to which the successive applications of tension 23, 24, 25 and 26 are applied, are, for example, distributed at substantially equal distances from each other and from the fixed points 14 and 18.

Upon successive thrusts, the central parts of the portions of strap are lifted by heights h1, h2, h3, h4 corresponding to the respective applications of tension leading to the formation of angles α, β between the direction of the strap before the application of pressure and the direction of the strap after the application of pressure, with a magnitude of a few degrees, for example 10 to 15°, for example 14°.

FIGS. 3A to 3D depict, in side views, the device 27 according to the embodiment of the invention more particularly described here, designed to lift a load 28 (represented by an arrow indicating a weight) at the end or distal part of the lever arm 29. The arm 29 is rotationally mobile about an axle 30 between a horizontal first position (FIG. 3A) and a substantially vertical final position (FIG. 3D).

In the remainder of the description, as far as possible, the same reference numerals will be used to denote elements that are identical or similar.

More specifically, using the device 27, tension is applied to the strap 12 of which the proximal end portion 11 is fixed at 13 to a base 14 and the distal end portion 15 is fixed at 16 to the proximal part 17 of the arm 29, there being provision to block the vertical movement of the strap using a roller 18 situated facing the rotation axle 30 with respect to the base. This fixing at 16 is performed for example removably by anchoring the strap on the lever arm at a distance d from the axle 30 of between 1/20 and ⅕, for example 1/10 of the length L of the lever arm.

The anchor point may also and for example be mounted as follows (an embodiment not depicted in the figures). The strap 12 in its distal end position 15 passes under or, more advantageously still, makes a complete turn around the axle 30 before then being fixed to the proximal part 17 of the arm 29 at the point 16 at the distance d.

According to this embodiment of the invention the device is therefore designed to apply successive pressures or tensions to the strap 12 according to the following steps.

A first application of tension 23 is first of all applied to a central portion 20, at the center thereof, thus lifting the inextensible strap, which to compensate brings about a first upward movement 31 of the lever arm (FIG. 3B).

This application of pressure tension may for example be achieved via thruster means, for example vertical pistons or rotary cams as will be described later on.

Next, a 2^{nd} application of tension 24 and a 3^{rd} application of tension 25 are applied simultaneously or successively, but in a manner that is closely spaced in time (for example less than one second, for example 1/10 of a second apart) to the strap portions 21, 22, and this once again allows the lever arm 29 to be moved upwards (arrow 32) into an intermediate raised position (FIG. 3).

These applications of tension are performed by moving the portions of inextensible strap vertically over a determined height.

FIG. 3D shows the final lifting step.

Here, the central portion 20 of the strap is once again moved upward by the thrust 26 thereby completing the rotational movement of the arm (arrow 33).

FIG. 4 shows the diagram 34 of forces and/or movements of the portions of strap showing a succession of cycles of thrusts on said strap 12, of the type of that shown in FIG. 2.

Only the three portions of strap 20, 21, 22 are activated here, the heightwise movements corresponding to the respective segments in the figure, CD, EG, FH, DI, GJ, HK, etc., the angles α and β between the portions of strap between the fixed points A and B and the thrust points being, as can be seen in the figure, by a few degrees with respect to the direction adopted by the strap in the previous application of tension, for example less than 10°.

FIG. 5 shows the curves of the variation in the thrusting heights (on the ordinate axis) with respect to time (abscissa axis) for the central first portion (curve 35) and for the second and third portions (curves 36 and 37 respectively drawn in chain line and in broken line) during the implementation of the cycles of FIG. 4.

FIG. 6 for its part shows an example of the variation (curve 38) in the angle adopted by the lifting arm during the implementation of the cycles of FIG. 4.

It may be noted that the variations in the angle show a continuous lift which may therefore extend as far as 90°.

FIGS. 7 and 8 show in side view and in perspective an exemplary embodiment of part of the device according to the invention using thrusting cams to achieve the application of tension to the strap.

As has been seen, this device acts on a lever arm 29 which is rotationally mobile about an axle 30 secured to a base 14.

This base 14 is formed of a framework, for example a metal framework, which may be of substantial weight (several hundreds of kilos for example) so as to absorb the stress loadings as the load is raised by the lever arm, or which is designed to be fixed solidly to the ground, or to a vehicle anchored in the ground.

The framework comprises two for example substantially rectangular side plates 39 to which there are fixed transversely, on the one hand, the rotation axle 30 of the lever arm on one side, and, on the other hand, on the other side, a bar 41 to which the point of attachment 42 of the portion 11 of strap 12 is fixed in a way known per se.

The framework additionally comprises three modules 43, 44, 45 supporting three cams 46, 47, 48. In this instance, two modules (43, 45) and two cams (46, 48) are identical in terms of size and configuration and designed respectively to activate the second and third portions of strap. They are positioned symmetrically with respect to the central module 44 provided with the cam 47 which is slightly different in form, for actuating the first portion of strap.

With reference to FIGS. 9 and 10, these cams are geometrically configured to carry out one or more cycles of application of determined transverse pressure to the strap, as described above.

They are for example driven by a single rotary motor 49, which is axial, via a single central axle 50 capable of causing the cams to rotate simultaneously, but allowing thrusts that are offset slightly in time, thereby considerably limiting (by dividing by a factor of three) the forces applied to the motor, which can therefore be less powerful, thereby reducing costs.

More specifically, the cams are in the form of circular or substantially circular disks 51, 52 comprising, on one of their faces 53, 54, a guide groove or rail 55, 56 in the form of a concentric spiral of determined length and trajectory so that, when followed, it generates a determined movement of successive thrusts and presses.

Each module additionally comprises a guide roller 57, 58 designed to collaborate with the corresponding groove or rail opposite. The guide roller is secured to a system of thrusters 59, 60. Each thruster system ends at the top in a ring 61, 62 designed to collaborate with the strap in such a way as to transmit to it the thrust from the thrusters system according to the determined cycle or cycles of pressure.

More specifically, each thruster system consists for example of a portal frame arm 63, 64 formed of parallel vertical uprights which is symmetric with respect to a geometric plane 65 of the base.

These arms support, at the plane of symmetry 65, the rings 61, 62 which are therefore situated centrally between these two arms.

The lifting of the load 28 will now be described with reference to FIGS. 3A to 3D.

In the initial state, the strap is horizontal and the cams are in the lowered position, no pressure being applied to the portions of strap opposite. Next, the rotary motor 49, controlled by a controller (not depicted) in a way known per se, and programmed accordingly, actuates the (simultaneous) rotation of the cams, although the grooves are designed to allow the first thrust 23 on the central part without allowing thrust on the second and third portions.

As the cams continue to rotate, it is then the turn of the grooves of the end cams 46, 48 to cause pressure to be applied to the second and then third portions at 1/10th of a second intervals to allow the continued raising of the arm 29. Immediately after the end of this raising, the central cam 47 then allows a second movement of the first portion (FIG. 3D) bringing the lever arm into the raised position (according to the cycle as programmed beforehand).

As goes without saying and as is evident from the foregoing, the present invention is not restricted to the embodiments more particularly described.

On the contrary, it encompasses all variants and notably those in which each cam is driven by a different motor and/or the cams are replaced by more conventional thruster means such as rams, for example electric rams.

1. A method for tensioning an inextensible or substantially inextensible longitudinal strap (12) comprising a distal end portion (15) and a proximal end portion (11), each end portion being respectively fixed to a corresponding anchor point (13, 16), characterized in that a cycle (2) of successive applications of transverse pressure to the strap (12) is applied, this cycle comprising a first application (23) of transverse pressure to a first portion (20) of the strap, followed by a second (24) and a third (25) application of transverse pressure to a second (21) and to a third (22) portion of said strap respectively.

2. The method as claimed in claim 1, characterized in that, with the proximal end portion (11) of the strap (12) fixed to a base (14) by a first of the anchor points (13) and the distal end portion (15) of the strap fixed to a proximal part (17) of a lever arm (29) rotationally mobile about an axle (19, 30) by the second of the anchor points (16), said lever arm extending between said proximal part and a distal part designed to support a load, the successive applications of pressure are designed to actuate the lifting of said lever arm between a first, rest, position and a second, working, position.

3. The method as claimed in claim 2, characterized in that, with a load (28) being fixed to the distal part of the lever arm (29), the cycle of applications of transverse pressure is performed in the form of successive vertical thrusts in the plane of movement to the strap fixed on one side to said proximal part of said arm and, on the other side, to a fixed point, the successive vertical thrusts on said strap being performed at least at three locations distributed along this strap so as to lift the load (28).

4. The method as claimed in claim 1, characterized in that the second and third applications of pressure are distributed symmetrically or substantially symmetrically on either side of the first application of pressure.

5. The method as claimed in claim 1, characterized in that the second and third applications of pressure are applied successively.

6. The method as claimed in claim 1, characterized in that, in order to perform the applications of pressure, the first, second and third portions of strap (20, 21, 22) are moved vertically over, respectively, a first, second and third determined height, then the first portion (20) is moved once again over a new determined height.

7. The method as claimed in claim 6, characterized in that the second and third determined heights are equal.

8. The method as claimed in claim 6, characterized in that the heights are arranged so that the angles (α, β) formed between the portions of strap and/or the anchor points adjacent to the portion to which pressure is applied are comprised between 5° and 15°.

9. The method as claimed in claim 1, characterized in that the pressure application cycle (2) is repeated at least N times, where N≥2.

10. The method as claimed in claim 1, characterized in that each cycle comprises at least a fourth and a fifth application of transverse pressure to a fourth and a fifth portion of strap respectively and/or an nth and an n+1^{th} application of pressure to an nth and an n+1^{th} portion of strap where n≥6, the nth and n+1^{th} portions being situated respectively on either side of the n−2^{th} and n−1^{th} portions of strap (12).

11. The method as claimed in claim 1, characterized in that the applications of pressure to the strap (12) are performed via rotary cams (46, 47, 48) configured to permit the successive pressure-application cycle or cycles for determined values of thrust.

12. A device (27) for tensioning an inextensible or substantially inextensible strap (12) extending longitudinally between a distal end portion (15) and a proximal end portion (11) which are respectively fixed to corresponding anchor points, characterized in that it comprises thruster means (43, 44, 45; 46, 47, 48; 49, 50) for applying transverse pressure to the strap, comprising first thruster means (44, 47) for applying transverse pressure to a first portion (20) of strap, second (43, 46) and third (45, 48) thruster means for applying transverse pressure to a second (21) and to a third (22) portion of strap respectively, and control means controlling said pressure-application thruster means and designed to perform at least one cycle of successive applications of pressure to the strap (12) on said first, second and third portions of said strap in a determined manner.

13. The device as claimed in claim 12, characterized in that it additionally comprises a lever arm (29) extending longitudinally between a proximal part and a distal part for supporting a load (28), the proximal part being rotationally mobile about an axle (30) fixed to a base (14), the distal portion of the strap being for its part fixed to said proximal end part of the arm by one of the anchor points (16), directly or via a pulley and/or via an axle of the rotary cylinder type, and the proximal end portion of the strap being fixed to a fixed point (13) forming the second of the anchor points.

14. The device as claimed in claim 12, characterized in that the thruster means and the rotation axle (30) of the arm are secured to the base (14) which is mobile.

15. The device as claimed in claim 12, characterized in that the device comprises three thruster means, namely a central means (44, 47) and two lateral means (43, 46, 45, 48) positioned symmetrically or substantially symmetrically with respect to the central means.

16. The device as claimed in claim 12, characterized in that the number of thruster means comprises n+2 thruster means where n is an uneven number greater than or equal to 3, distributed longitudinally along the strap (12), symmetrically with respect to the central thruster means situated equidistant between the fixed point and a return pulley or rotary cylinder situated in the same longitudinal plane as the fixed point.

17. The device as claimed in claim 12, characterized in that the thruster means comprise cams (43, 44, 45) of a geometry configured to perform one or more determined cycles of applications of transverse pressure to the strap.

18. The device as claimed in claim 17, characterized in that the cams are activated in rotation by one and the same single rotary motor (49).

19. The device as claimed in claim 17, characterized in that each thruster means comprises a cam (43, 44, 45) in the form of a substantially circular disk comprising, on one of its faces (53, 54), a guide groove or rail (55, 56) in the form of a concentric spiral of determined length and trajectory, a guide roller (57, 58) designed to collaborate with the groove or rail opposite, secured to a thruster system, and said thruster system (63, 64) ending at the top in a ring (61, 62) designed to collaborate with the strap in such a way as to transmit the thrust of the thruster system to it according to the determined pressure cycle or cycles.
